(19) United States
(12) Patent Application Publication
(10) Pub. No.: US 2011/0156417 A1
(43) Pub. Date: Jun. 30, 2011

(54) Method of operating a robot and apparatus comprising a robot

(75) Inventor: Guenther Weber, Gross Nemerow (DE)

(73) Assignee: Weber Maschinenbau GmbH Breidenbach, Breidenbach (DE)

(21) Appl. No.: 12/968,928

(22) Filed: Dec. 15, 2010

(30) Foreign Application Priority Data
Dec. 22, 2009 (DE) 10 2009 060 063.9

(51) Int. Cl. B25J 19/00

(52) U.S. Cl. 294/213

(57) ABSTRACT

A robot includes a kinematic mechanism and an end effector coupled to the kinematic mechanism for transferring products, in particular food products. The end effector is automatically cleaned on the satisfaction of a cleaning criterion.

The present invention relates to a method of operating a robot which comprises a kinematic mechanism and an end effector coupled to the kinematic mechanism for transferring products. The invention further relates to an apparatus comprising such a robot.

Robots of the named kind are used, for example, in the food industry to transfer food products such as meat, sausage or cheese from a first conveying means to a second conveying means, to sort them or to introduce them into a packaging. For this purpose, the end effector is moved relative to a fixed-position base by means of the kinematic mechanism. The end effector can be any desired tool by means of which the corresponding products can be picked up, transported and placed down. A product gripper can, for example, be provided which has two blades gripping beneath the products or a vacuum suction apparatus.

Contaminations at the end effector can occur by the contact of the end effector with the food products and said contaminants can be problematic in a hygienic respect. Product residues can, for example, adhere to the end effector or a fine film of biological material can form. A corresponding cleaning by a user is complex and requires an undesirably long interruption of robot operation.

It is therefore an object of the invention to increase the hygienic degree of quality in a robot of the generic kind with interventions into the operating procedure which are as minor as possible.

The object is satisfied by a method having the features of claim 1.

The end effector is automatically cleaned in accordance with the invention on the satisfaction of a cleaning criterion. The cleaning criterion can be fixed in dependence on the respective application and on the hygienic requirements. If the cleaning criterion is satisfied, the cleaning of the end effector can be triggered, for example, by a control device of the robot or by an external control device. In this manner, the satisfaction of the hygienic requirements is always ensured, in particular without an active intervention of a user being necessary.

In accordance with an embodiment, the end effector to be cleaned is moved automatically, in particular by the robot itself, into the region of action of a cleaning device and is cleaned by it. The end effector is preferably introduced directly into the cleaning device by the robot. The cleaning device is for this purpose advantageously located within a region of action of the robot and can in particular form a part of the product transfer apparatus. Alternatively, the end effector could, however, also be brought by the robot into a coupling station in which it is decoupled from the kinematic mechanism and from where it is transported further into the region of action of the cleaning device.

In accordance with a further embodiment, the end effector to be cleaned is decoupled from the kinematic mechanism before its cleaning. A decoupled end effector can be cleaned easily and in particular reliably from all sides, while the robot is available for other purposes during the cleaning of the end effector and does not have to dwell motionlessly in a cleaning position. In addition, after the decoupling of the end effector to be cleaned, a clean replacement end effector can be coupled to the kinematic mechanism and the transfer of products can be continued during the cleaning. This is advantageous in that then no significant interruption of the product transfer operation is caused by the cleaning and there are no substantial losses in speed or throughput with respect to the operation of the associated product processing plant. At the same time, the cleaning of the end effector can be carried out with the thoroughness corresponding to the requirements since there is sufficient time available for the cleaning due to the robot continuing to operate.

In accordance with a further embodiment, a previously cleaned end effector is coupled to the kinematic mechanism as a replacement end effector. For this purpose, the cleaning device can be designed such that a plurality of end effectors have room therein. Alternatively, a second cleaning device can also be provided from which a clean replacement end effector can be removed. In both cases, a complex provision of reconditioned replacement end effectors is dispensed with. It is rather the case that only a change or replacement within an anyway present set of end effectors is carried out.

Both the decoupling of the end effector from the kinematic mechanism and the decoupling of the replacement end effector to the kinematic mechanism advantageously take place directly in the cleaning device. On a required cleaning, the dirty end effector is therefore first moved into the cleaning device and is decoupled from the kinematic mechanism there. The kinematic mechanism from which the dirty end effector was decoupled is subsequently moved to the replacement end effector likewise located in the cleaning device or located in a further cleaning device and is automatically coupled to said replacement end effector.

Alternatively, a coupling station can also be provided in which a dirty end effector is placed down and a clean replacement end effector is provided, with the end effector and the replacement end effector being able to be transported to and fro between the coupling station and at least one cleaning device. Such a coupling station so-to-say represents an interface between the robot and the at least one cleaning device.

In accordance with a further embodiment, the automatic cleaning takes place in predetermined, in particular regular, time intervals. A detection by sensor of the contamination state of the end effector is not necessary in this case. The controller of the robot and the cleaning device can accordingly be designed particularly simply.

Alternatively or additionally, the automatic cleaning can also take place after a predetermined number of transfer procedures. In this respect, the fact is taken into account that contaminations or dirt mainly occur during a transfer procedure so that a conclusion can therefore relatively reliably be made on the actual degree of contamination by the number of transfer procedures. The two criteria “time interval” and “number of transfer procedures” can also be associated with one another in a suitable manner. An automatic cleaning can thus, for example, therefore only be carried out when a predetermined time interval from the preceding end effector change is present and additionally a predetermined number of transfer processes has taken place since the preceding end effector change.

Alternatively or additionally, the degree of contamination or dirt of the end effector can be determined by a sensor, with a cleaning always being initiated when the detected degree of contamination or dirt exceeds a threshold value.

The object underlying the invention is furthermore satisfied by an apparatus having the features of claim 9. The apparatus in accordance with the invention includes a robot which has a kinematic mechanism and an end effector coupled to the kinematic mechanism for the transfer of products, in particular food products, and a cleaning device for the automatic cleaning of the end effector on the satisfaction of a cleaning criterion. The method in accordance with the invention can be carried out with the help of the apparatus in accordance with the invention so that the previously described advantages also apply to the apparatus.

In accordance with an embodiment, the cleaning device is arranged within the region of action of the robot. In this manner, the robot can itself introduce its end effector directly into the cleaning device. Alternatively, a coupling station is arranged within the region of action can also be imagined from where a dirty end effector decoupled from the kinematic mechanism can be brought to a cleaning device located outside the region of action.

In accordance with a further embodiment, a clean replacement end effector is present in the cleaning device and can be coupled to the kinematic mechanism instead of the end effector to be cleaned. The replacement end effector is preferably available for the end effector to be cleaned in the direct environment of the decoupling location, whereby the travel paths of the robot kinematic mechanism are minimized for an end effector change to take place.

Further advantageous embodiments of the invention can be seen from the dependent claims, from the description and from the drawing.

The invention will be described in the following purely by way of example with reference to a possible embodiment and to the enclosed drawing.

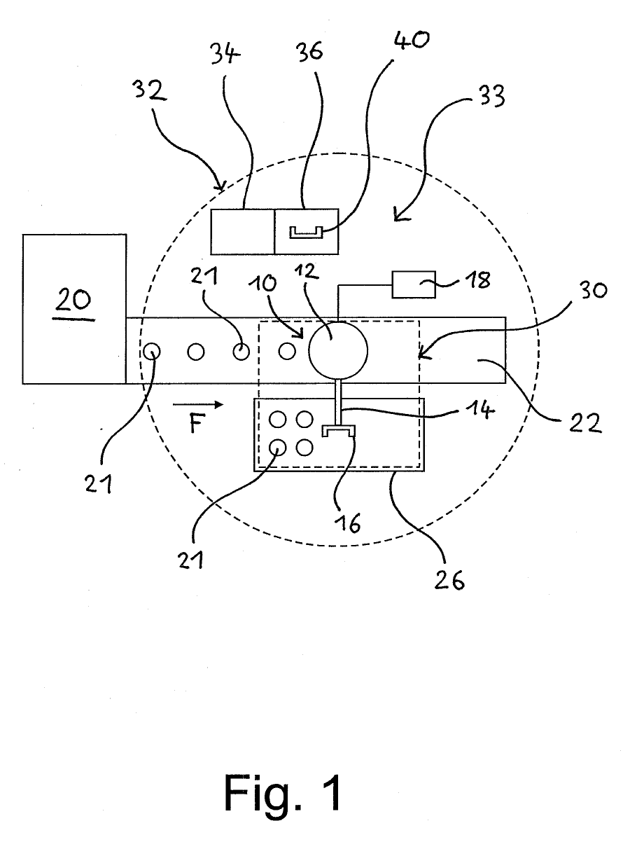

FIG. 1 shows a schematic plan view of an apparatus in accordance with the invention for handling food products which includes a robot for transferring the food products.

In accordance with FIG. 1, a robot 10 includes a fixed-position base 12, a kinematic mechanism 14 movably attached thereto and also an end effector 16, e.g. a product gripper, coupled to the kinematic mechanism 14. The robot 10, which can e.g. be a delta robot or parallel robot, is arranged in a production line with a cutting apparatus, here a high performance slicer 20, for slicing food products and a packaging machine 26 arranged after the slicer 20 for the manufacture of portion packagings ready for sale.

The food product to be sliced is first sliced into product slices by the slicer 20, with a plurality of product slicers each being able to form a portion 21 of the food product. The portions 21 are transported along a conveying direction F to the robot 10 by means of a belt conveyor 22, said robot picking up the portions 21 from the belt conveyor 22 by means of the end effector 16 and placing them at a predetermined placement location in the packaging machine 26.

The region within which the robot 10 picks up and places down portions 21 defines a working region 30 of the robot 10. The total region of action 32 of the robot 10, that is that region which can generally be reached by the kinematic mechanism 14 or by the end effector 16 coupled thereto, includes the working region 30 and a further region 33 not used during the normal transfer operation.

A first cleaning device 34 and a second cleaning device 36 are provided in this non-used region 33. The cleaning devices 34, 36 can be apparatus familiar to the skilled person such as immersion baths, spray apparatus, ultrasound devices or the like. The end effector 16 of the robot 10 is automatically cleaned at regular time intervals by means of the cleaning devices 34, 36 as will be described in more detail in the following.

As soon as a control device 18 associated with the robot 10 finds that a predetermined time interval has passed, it triggers an automatic cleaning of the end effector 16. For this purpose, the kinematic mechanism 14 of the robot 10 is moved out of the working region 30 and toward the first cleaning device 34. As soon as the end effector 16 is located in the first cleaning device 34, it is decoupled from the kinematic mechanism 14. Subsequently, the kinematic mechanism 14 is moved toward the second cleaning device 36 in which a clean replacement end effector 40 is located. The replacement end effector 40 is coupled to the kinematic mechanism 14 and is moved by means of the kinematic mechanism 14 into the working region 30 to continue the transfer of the portions 21. The replacement end effector 40 is an end effector which is equivalent to the end effector 16 to be cleaned and which was e.g. previously cleaned in the second cleaning device 36.

While the robot 10 continues to work with the replacement end effector 40, the end effector 16 is cleaned in the first cleaning device 34. The portions 21 therefore continue to be transferred during the cleaning of the end effector 16 so that the operation of the slicer 20 or of the belt conveyor 22 at least does not have to be interrupted for long for the cleaning. The duration up to the next gripper change is available for the cleaning of the end effector 16.

After a further end of the predetermined time interval, the replacement end effector 40 is then decoupled in the second cleaning device 36 and the original end effector 16 is again coupled to the kinematic mechanism 14 and removed from the first cleaning device 34.

In this manner, the end effectors 16, 40 are therefore mutually replaced at regular time intervals so that a respective one of the end effectors 16, 40 is in one of the cleaning devices 34, 36 and the respective other end effector 40, 16 is coupled to the kinematic mechanism 14 of the robot 10 and is in use.

It is ensured by the regularly occurring end effector change in conjunction with a respective cleaning procedure that the robot 10 always satisfies the prescribed hygiene demands. An operator of the plant therefore no longer has to take care of when and to what extent a cleaning of the end effector 16 must be carried out.

### REFERENCE NUMERAL LIST

10 robot
12 base
14 kinematic mechanism
16 end effector
18 control device
20 slicer
21 portion
22 belt conveyor
26 packaging machine
30 working region
32 region of action
33 non-used region
34 first cleaning device
36 second cleaning device
40 replacement end effector
F conveying direction

1. A method of operating a robot (10) which includes a kinematic mechanism (14) and an end effector (16) coupled to the kinematic mechanism (14) for transferring products (21), in particular food products,
characterized in that
the end effector (16) is automatically cleaned on the satisfaction of a cleaning criterion.

2. A method in accordance with claim 1,
characterized in that
the end effector (16) to be cleaned is automatically moved into the region of action of a cleaning device (34) and is cleaned by it.

3. A method in accordance with claim 1,
characterized in that
the end effector (16) to be cleaned is decoupled from the kinematic mechanism (14) before its cleaning.

4. A method in accordance with claim 3,
characterized in that
a replacement end effector (40) is coupled to the kinematic mechanism (14) after the decoupling of the end effector (16) to be cleaned and the transfer of products (21) is continued during the cleaning.

5. A method in accordance with claim 4,
characterized in that
a previously cleaned end effector is coupled to the kinematic mechanism (14) as the replacement end effector (40)

6. A method in accordance with claim 4,
characterized in that
the decoupling of the end effector (16) from the kinematic mechanism (14) or the coupling of the replacement end effector (40) to the kinematic mechanism (14) takes place in the cleaning device (34, 36).

7. A method in accordance with claim 1,
characterized in that
the automatic cleaning takes place at predetermined, in particular regular, time intervals.

8. A method in accordance with claim 1,
characterized in that
the automatic cleaning takes place after a predetermined number of transfer procedures.

9. A product transfer apparatus, comprising a robot (10) which includes a kinematic mechanism (14) and an end effector (16) coupled to the kinematic mechanism (14) for transferring products (21), in particular food products, and comprising a cleaning device (34) for the automatic cleaning of the end effector (16) on the satisfaction of a cleaning criterion.

10. An apparatus in accordance with claim 9,
characterized in that
the cleaning device (34) is arranged within a region of action (32) of the robot (10).

11. An apparatus in accordance with claim 9,
characterized in that
a clean replacement end effector (40) is present in the cleaning device (36) which can be coupled to the kinematic mechanism (14) instead of the end effector (16) to be cleaned.
